(19) United States
(12) Patent Application Publication
(10) Pub. No.: US 2023/0261982 A1
(43) Pub. Date: Aug. 17, 2023

(54) NODE CONFIGURATION METHOD, CONTROLLER, AND NODE

(71) Applicant: HUAWEI TECHNOLOGIES CO., LTD., Shenzhen (CN)

(72) Inventors: Min Zhao, Shenzhen (CN); Yixiao Chen, Ottawa (CA); Gang Xie, Wuhan (CN)

(21) Appl. No.: 18/301,092

(22) Filed: Apr. 14, 2023

Related U.S. Application Data
(63) Continuation of application No. PCT/CN2021/112956, filed on Aug. 17, 2021.

(30) Foreign Application Priority Data
Oct. 15, 2020 (CN) 202011105791.6

(51) Int. Cl. H04L 45/00; H04L 45/16; H04L 45/02

(52) U.S. Cl. CPC H04L 45/32; H04L 45/16; H04L 45/02

(57) ABSTRACT

This application provides a node configuration method, wherein the method includes: First, determinning a target network based on an original network, where the original network is for flooding control topology information, the target network is for flooding the service topology information, and a quantity of flooding paths in the target network is less than a quantity of flooding paths in the original network. Next, determinning attributes of all interfaces on each node, where the attributes of the interfaces include a first attribute and a second attribute, an interface with the first attribute is configured to flood the service topology information. Further, generating first configuration information based on the attributes of all the interfaces on each node, and sends, to each node, the first configuration information corresponding to each node, where the first configuration information indicates each node to configure the attributes of all the local interfaces.

### CROSS-REFERENCE TO RELATED APPLICATIONS

This application is a continuation of International Application No. PCT/CN2021/112956, filed on Aug. 17, 2021, which claims priority to Chinese Patent Application No. 202011105791.6, filed on Oct. 15, 2020. The disclosures of the aforementioned applications are hereby incorporated by reference in their entireties.

### TECHNICAL FIELD

This application relates to the communication field, and in particular, to a node configuration method, a controller, and a node.

### BACKGROUND

The open shortest path first (OSPF) is an internal gateway routing protocol based on a link state. The link state refers to an interface parameter or a link parameter of a router. Routers exchange link-state advertisements (LSAs) instead of routing tables. Each router has a link state of the router that is called a local link state. Local link states are advertised in OSPF routing domain until all the routers have a complete and identical link-state database.

In a current OSPF flooding process, when receiving an LSA from an interface, a node may advertise the LSA through all other interfaces of the node. In other words, another node may receive the same LSA from a plurality of interfaces. This mechanism ensures network reliability, but a large quantity of redundant packets may easily increase burdens of network bandwidth.

### SUMMARY

This application provides a node configuration method, a controller, and a node, to reduce flooding paths of service topology information and lighten burdens of network bandwidth and processing burdens of each node.

According to a first aspect, this application provides a node configuration method. The method includes a plurality of steps. First, a controller determines a target network based on an original network, where the original network is for flooding control topology information, the target network is for flooding service topology information, and a quantity of flooding paths in the target network is less than a quantity of flooding paths in the original network. Next, the controller determines attributes of all interfaces on each node, where the attributes of the interfaces include a first attribute and a second attribute, an interface with the first attribute is configured to flood the service topology information, and an interface with the second attribute is not configured to flood the service topology information. Further, the controller generates first configuration information based on the attributes of all the interfaces on each node, and sends, to each node, the first configuration information corresponding to each node. The first configuration information indicates each node to configure the attributes of all the local interfaces.

In this implementation, because the quantity of flooding paths in the target network is less than the quantity of flooding paths in the original network, a flooding process of the service topology information between nodes is different from that of the control topology information, and each node may flood the service topology information only through a specified interface, but not flood the service topology information to adjacent nodes of all interfaces. This reduces flooding paths of the service topology information and lightens burdens of network bandwidth and processing burdens of each node. Moreover, in this application, the nodes do not need to determine respective interface attributes through packet interaction. The interface attributes of each node are determined by the controller together. In this way, global performance is better and applicability is wider.

In some possible implementations, that a controller determines a target network based on an original network includes:

The controller determines the target network based on the original network and a minimum spanning tree algorithm. The minimum spanning tree algorithm may enable all nodes to be connected (from one node to any other node), and cause a smallest total quantity of paths for synchronization of the service topology information flooded by all the nodes. This minimizes the burdens of network bandwidth and the processing burdens of each node.

In some possible implementations, the attributes of the interfaces further include a third attribute, and an interface with the third attribute is a backup interface that is on a node and that is for flooding the service topology information. In addition, a first node and a second node include the interface with the third attribute. The method further includes:

The controller sends second configuration information to the first node. If a link between an interface with the first attribute on the second node and an interface with the first attribute on a third node is faulty, the second configuration information indicates the first node to flood the service topology information to the interface with the third attribute on the second node through the local interface with the third attribute. In this implementation, if the link between the two nodes is faulty, a backup link (namely, a link corresponding to the interface with the third attribute) may be enabled to ensure normal operation of flooding. In addition, the first node may flood the service topology information to the second node without waiting for an interface attribute re-delivered by the controller based on fault information, thereby improving flooding efficiency.

In some possible implementations, if a link between an interface with the first attribute on a second node and an interface with the first attribute on a third node is faulty, the method further includes:

The controller receives fault information sent by the second node and/or the third node, where the fault information indicates that the link is faulty. A fault reporting mechanism in embodiments of this application enables the controller to obtain the fault information in a timely manner and perform corresponding processing, to ensure that the flooding process is not interrupted.

In some possible implementations, the attributes of the interfaces further include a third attribute, an interface with the third attribute is a backup interface that is on a node and that is for flooding the service topology information, a first node and the second node include the interface with the third attribute, and the method further includes:

The controller updates an attribute of the interface on the first node, attributes of the interfaces on the second node, and an attribute of the interface on the third node based on the fault information. The attribute of the interface between the second node and the third node is updated to the second attribute, and the attribute of the interface between the first node and the second node is updated to the first attribute. Further, the controller generates third configuration information and sends the third configuration information to the first node, the second node, and the third node. The third configuration information indicates the first node, the second node, and the third node to update the attributes of the local interfaces. In this implementation, the controller reconfigures the interface attributes for fault-related nodes based on the fault information reported by the node. This mechanism for coping with a link fault is more practical.

In some possible implementations, the control topology information includes a link-state advertisement (LSA), and the service topology information includes traffic engineering (TE) topology information.

According to a second aspect, this application provides a controller, including a processor, a memory, and a transceiver. The processor, the memory, and the transceiver are connected to each other through a line.

The processor is configured to: determine a target network based on an original network, where the original network is for flooding control topology information, the target network is for flooding service topology information, and a quantity of flooding paths in the target network is less than a quantity of flooding paths in the original network; determine attributes of all interfaces on each node, where the attributes of the interfaces include a first attribute and a second attribute, an interface with the first attribute is configured to flood the service topology information, and an interface with the second attribute is not configured to flood the service topology information; and generate first configuration information based on the attributes of all the interfaces on each node.

The transceiver is configured to: send, to each node, the first configuration information corresponding to each node. The first configuration information indicates each node to configure the attributes of all the local interfaces.

In some possible implementations, the processor is specifically configured to: determine the target network based on the original network and a minimum spanning tree algorithm, where the target network has a smallest quantity of flooding paths.

In some possible implementations, the attributes of the interfaces further include a third attribute, and an interface with the third attribute is a backup interface that is on a node and that is for flooding the service topology information. A first node and a second node include the interface with the third attribute. The processor is further configured to: send second configuration information to the first node. If a link between an interface with the first attribute on the second node and an interface with the first attribute on a third node is faulty, the second configuration information indicates the first node to flood the service topology information to the interface with the third attribute on the second node through the local interface with the third attribute.

In some possible implementations, if a link between an interface with the first attribute on a second node and an interface with the first attribute on a third node is faulty, the transceiver is further configured to: receive fault information sent by the second node and/or the third node, where the fault information indicates that the link is faulty.

In some possible implementations, the attributes of the interfaces further include a third attribute, and an interface with the third attribute is a backup interface on a node for flooding the service topology information. A first node and the second node include the interface with the third attribute. The processor is further configured to: update an attribute of the interface on the first node, attributes of the interfaces on the second node, and an attribute of the interface on the third node based on the fault information. The attribute of the interface between the second node and the third node is updated to the second attribute, and the attribute of the interface between the first node and the second node is updated to the first attribute. Further, the processor is configured to generate third configuration information. The transceiver is further configured to: send the third configuration information to the first node, the second node, and the third node. The third configuration information indicates the first node, the second node, and the third node to update the attributes of the local interfaces.

In some possible implementations, the control topology information includes an LSA and the service topology information includes TE topology information.

According to a third aspect, this application provides a node, including a processor, a memory, and a transceiver. The processor, the memory, and the transceiver are connected to each other through a line.

The transceiver is configured to: receive first configuration information sent by a controller. The first configuration information is generated by the controller based on attributes of all interfaces on the node, the attributes of the interfaces include a first attribute and a second attribute, an interface with the first attribute is configured to flood service topology information, and an interface with the second attribute is not configured to flood the service topology information. A quantity of flooding paths of the service topology information in a network in which the node is located is less than a quantity of flooding paths of control topology information.

The processor is configured to: configure the attributes of all the local interfaces based on the first configuration information.

In some possible implementations, the node further includes an interface with a third attribute, and the interface with the third attribute is a backup interface that is on the node and that is for flooding the service topology information. The transceiver is further configured to: receive second configuration information sent by the controller. If a link between an interface with the first attribute on a first node and an interface with the first attribute on a second node is faulty, the processor is further configured to: flood the service topology information to the first node through the local interface with the third attribute based on an indication of the second configuration information.

In some possible implementations, when a link between an interface with the first attribute on the node and a peer interface is faulty, the transceiver is further configured to: send fault information to the controller, where the fault information indicates that the link is faulty; and receive third configuration information sent by the controller. The processor is further configured to: update the attributes of the local interfaces based on the third configuration information.

According to a fourth aspect, this application provides a computer-readable storage medium. The computer-readable storage medium stores a computer program. When the computer program is executed by hardware, some or all of the steps of any method provided in the first aspect can be implemented.

According to a fifth aspect, this application provides a communication system. The communication system includes the controller described in the second aspect and the node described in the third aspect.

The controller determines a target network based on an original network, where the original network is for flooding control topology information, the target network is for flooding service topology information, and a quantity of flooding paths in the target network is less than a quantity of flooding paths in the original network. Next, the controller determines attributes of all interfaces on each node, where the attributes of the interfaces include a first attribute and a second attribute, an interface with the first attribute is configured to flood the service topology information, and an interface with the second attribute is not configured to flood the service topology information. Further, the controller generates first configuration information based on the attributes of all the interfaces on each node, and sends, to each node, the first configuration information corresponding to each node. The first configuration information indicates each node to configure the attributes of all the local interfaces.

The node configures the attributes of all the local interfaces based on the first configuration information.

In embodiments of this application, because the quantity of flooding paths in the target network is less than the quantity of flooding paths in the original network, a flooding process of the service topology information between nodes is different from that of the control topology information, and each node may flood the service topology information only through a specified interface, but not flood the service topology information to adjacent nodes of all interfaces. This reduces flooding paths of the service topology information and lightens burdens of network bandwidth and processing burdens of each node. Moreover, in this application, the nodes do not need to determine respective interface attributes through packet interaction. The interface attributes of each node are determined by the controller together. In this way, global performance is better and applicability is wider.

### BRIEF DESCRIPTION OF DRAWINGS

FIG. 1 is a schematic diagram of a first network topology according to an embodiment of this application;

FIG. 2 is a schematic diagram of an embodiment of a node configuration method according to an embodiment of this application;

FIG. 3 is a schematic diagram of a second network topology according to an embodiment of this application;

FIG. 4 is a schematic diagram of a third network topology according to an embodiment of this application;

FIG. 5 is a schematic diagram of a fourth network topology according to an embodiment of this application;

FIG. 6 is a schematic diagram of a fifth network topology according to an embodiment of this application;

FIG. 7 is a schematic diagram of a sixth network topology according to an embodiment of this application;

FIG. 8 is a schematic diagram of a structure of a controller according to an embodiment of this application; and

FIG. 9 is a schematic diagram of a structure of a node according to an embodiment of this application.

### DESCRIPTION OF EMBODIMENTS

Embodiments of this application provide a node configuration method, a controller, and a node. A flooding process of service topology information between nodes is different from that of control topology information, and each node may flood the service topology information only through a specified interface, but not flood the service topology information to adjacent nodes of all interfaces. This reduces flooding paths of the service topology information and lightens burdens of network bandwidth.

It should be noted that, the terms “first”, “second”, “third”, and the like in the specification, claims, and accompanying drawings of this application are used to distinguish between similar objects, but do not limit a specific order or sequence. It should be understood that the foregoing terms are interchangeable in proper circumstances, so that embodiments described in this application can be implemented in other orders rather than the content described in this application. Moreover, the terms “include”, “have”, or any other variant thereof are intended to cover non-exclusive inclusion. For example, processes, methods, systems, products, or devices that include a series of steps or units are not limited to the steps or the units that are clearly listed, and may include other steps and units that are not clearly listed or that are inherent to the processes, methods, products, or devices.

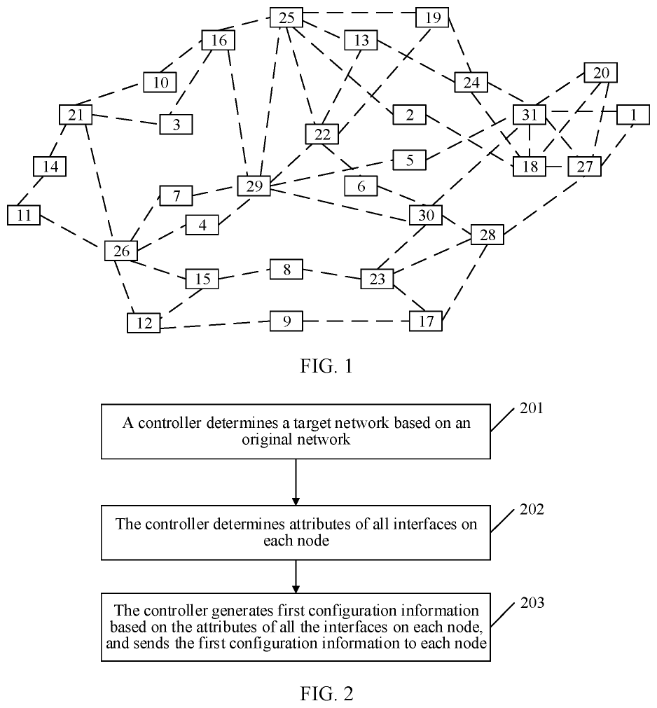

FIG. 1 is a schematic diagram of a first network topology according to an embodiment of this application. This application is mainly applied to an open shortest path first (OSPF) multi-access network topology. Nodes exchange link-state advertisements (LSAs) instead of routing tables. The LSA may indicate an interface parameter or a link parameter of a node, for example, including an internet protocol (IP) address, a subnet mask, and a network type on an interface. A node may send an LSA of the node to all adjacent nodes. An adjacent node places the received LSA into a local link-state database (Link-State Database) and then sends the LSA to all nodes adjacent to the adjacent node. Through such a transmission process, each node may have all link states in a network, and link states of all nodes can depict a same network topology. It should be understood that dashed lines in the network topology shown in FIG. 1 indicate paths for flooding the LSAs between nodes.

It should be noted that, in the foregoing flooding manner, some nodes may receive identical LSAs from a plurality of interfaces. As shown in FIG. 1, a node 16 may receive LSAs from a node 3, a node 10, a node 29, and a node 25. The node 16 may inevitably receive some duplicate LSAs. This mechanism ensures reliability of a system, but there is also information redundancy.

In particular, a network to which this application is applied may be divided into a control plane and a service plane. In the network, service topology information that needs to be transmitted is far more than control topology information that needs to be transmitted. If the service topology information in the network is also flooded in the foregoing manner, burdens of global network bandwidth and processing pressure of each node may inevitably increase.

Therefore, this application provides a node configuration method, to reduce flooding paths of the service topology information and lighten the burdens of the network bandwidth. The following provides detailed descriptions.

FIG. 2 is a schematic diagram of an embodiment of a node configuration method according to an embodiment of this application. In an example, the node configuration method includes the following steps.

201: A controller determines a target network based on an original network.

In this embodiment, each node may complete network-wide synchronization of control topology information in a conventional OSPF flooding manner, and the original network for flooding the control topology information may be obtained through this process. The original network may be shown in FIG. 1. For the flooding process of the control topology information, refer to related descriptions in FIG. 1. The control topology information may be specifically an LSA, and details are not described herein again. It should be understood that the node described in this application may also be referred to as a “network element”, a “router”, or the like. A specific name of the node is not limited in this application.

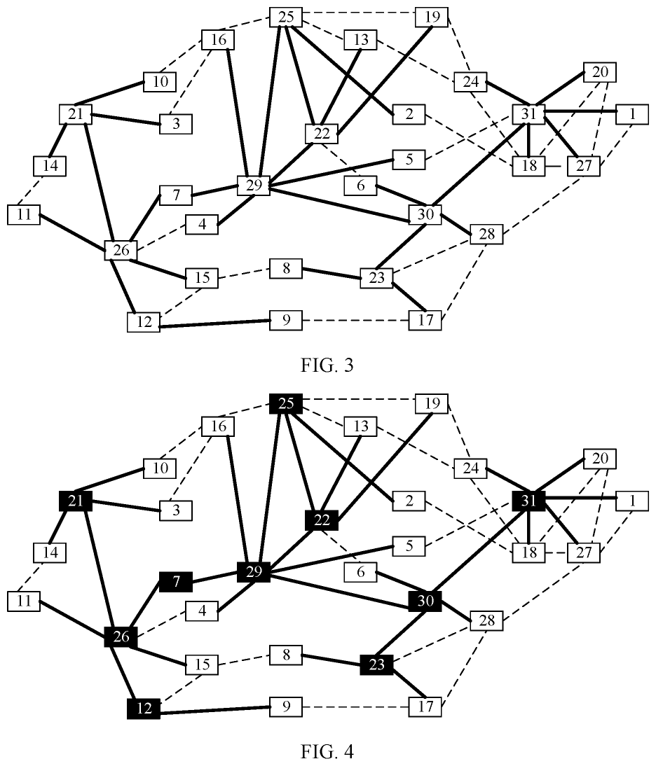

FIG. 3 is a schematic diagram of a second network topology according to an embodiment of this application. The controller may determine the target network based on the original network. The target network is for transmitting service topology information. In addition, a quantity of flooding paths in the target network is less than a quantity of flooding paths in the original network. As shown in FIG. 3, solid lines in the target network indicate paths for flooding the service topology information between nodes, and a quantity of paths for flooding the service topology information in FIG. 3 is less than a quantity of paths for flooding the control topology information in FIG. 1. The service topology information may specifically include service-related resource information such as available service bandwidth and a service delay. It should be understood that, decoupling of the original network and the target network in embodiments is to reduce flooding paths of the service topology information, but forwarding paths of service data are not limited, in other words, the service data may be forwarded on a link between nodes in the network.

In a possible implementation, the controller may determine the target network based on the original network and a minimum spanning tree algorithm. It should be understood that, the minimum spanning tree algorithm may enable all nodes to be connected (from one node to any other node), and cause a smallest total quantity of paths for synchronization of the service topology information flooded by all the nodes. FIG. 4 is a schematic diagram of a third network topology according to an embodiment of this application. As shown in FIG. 4, all nodes in the target network obtained based on the minimum spanning tree algorithm may be classified into trunk nodes (such as black border nodes in FIG. 4) and branch nodes (such as white border nodes in FIG. 4). It can be seen that no flooding path of the service topology information is established between adjacent branch nodes.

It should be noted that OSPF-based flooding may easily cause partial congestion, and this may be resolved by introducing a traffic engineering (TE) technology. To be specific, the service topology information may be specifically TE topology information, and the TE topology information includes maximum link bandwidth, maximum reservable bandwidth, current reserved bandwidth, a priority, and the like of a TE link.

202: The controller determines attributes of all interfaces on each node.

The controller may determine the attributes of all the interfaces on each node based on the target network. The attributes of the interfaces include a first attribute and a second attribute. It should be understood that an interface with the first attribute on a node is configured to flood the service topology information. An interface with the second attribute on the node is not configured to flood the service topology information, but may flood the control topology information. Specifically, the first attribute may also be referred to as a mobile ad hoc network designated router (MDR). A peer interface of the interface with the second attribute on the node is an interface on a non-specified node. The node may flood service topology information to a corresponding adjacent node through the interface with the first attribute, and receive service topology information flooded by another node. For example, a node 26 shown in FIG. 4 has four interfaces, respectively corresponding to a node 11, a node 21, a node 7, and a node 4. Attributes of the three interfaces corresponding to the node 11, the node 21, and the node 7 are the first attribute, and an attribute of the interface corresponding to the node 4 is the second attribute. In this case, the service topology information generated by the node 26 may be flooded to the node 11, the node 21, and the node 7, but not to the node 4.

203: The controller generates first configuration information based on the attributes of all the interfaces on each node, and sends the first configuration information to each node.

After receiving the corresponding first configuration information, each node may complete attribute configuration of the local interfaces, and then flood the service topology information based on attributes of the local interfaces. Specifically, if a node generates new service topology information, the node floods the service topology information to an adjacent node through a local interface with the first attribute. FIG. 4 is used as an example. A trunk node 29 generates new service topology information, and the trunk node 29 floods the service topology information through interfaces corresponding to the node 7, the node 4, a node 30, a node 5, a node 22, a node 25, and a node 16. For another example, if the branch node 11 generates service topology information, the branch node 11 floods the service topology information through the interface corresponding to the node 26. If a node receives service topology information, the node floods the service topology information to an adjacent node through another local interface with the first attribute. For example, if the node 29 receives service topology information flooded by the node 7, the node 29 floods the service topology information through the interfaces corresponding to the node 4, the node 30, the node 5, the node 22, the node 25, and the node 16.

In some possible implementations, the controller may alternatively send first configuration information of all the nodes to one of the nodes. After completing attribute configuration of local interfaces, the node may flood first configuration information of another node through the flooding paths of the target network. The another node may determine, based on an identifier in the first configuration information, the first configuration information corresponding to the another node. Through such a flooding process, each node may receive the respective first configuration information, and complete attribute configuration of the local interfaces.

It should be noted that, in an actual application, a node or a link between nodes may also be faulty. In this case, to ensure that the service topology information can be normally flooded between nodes, a backup path needs to be enabled. The following provides further descriptions.

In this embodiment, there is no loop in the target network generated based on the minimum spanning tree algorithm. FIG. 4 is used as an example. A link 11-26-21-14 is included in the target network, and a link 14-11 is not a link in the target network. Therefore, no loop is formed. The controller may determine the backup path through loop calculation, that is, each node needs to be in at least one protection loop. For example, if a link 21-14 is faulty, the node 11 may replace the node 21 to flood the service topology information to a node 14, and the controller may update the target network on this basis. Preferably, if a node is in a plurality of loops, the backup path may be selected from a loop with minimum hops.

It should be understood that, the attributes of the interfaces on the node may further include a third attribute, an interface with the third attribute on the node is a backup interface that is configured to flood the service topology information and that is on the node. The third attribute may also be referred to as a backup designated router (BDR) or a backup mobile ad hoc network designated router (BMDR). It should be noted that, each node needs to have one or more interfaces with the first attribute. If a node has only one interface with the first attribute, the node needs to further have at least one interface with the third attribute. If a link corresponding to the interface that is with the first attribute and that is on the node is faulty, the node may further receive, through the interface with the third attribute, service topology information flooded by another node. The following provides detailed descriptions.

In this embodiment, a response mechanism may be for determining whether a link or a node is faulty. Specifically, if a node A receives service topology information from a node B through an interface with the first attribute, the node A sends an acknowledgment message to the node B through the interface with the first attribute, to notify the peer end that service data has been received. Moreover, the node A may further send the acknowledgment message to a node C through an interface with the third attribute. If the node B and the node C can receive the acknowledgment message from the node A, it can be determined that a link between the node A and the node B is normal. If neither the node B nor the node C receives the acknowledgment message from the node A within preset duration, it can be determined that a link between the node A and the node B is faulty. Further, the node B or the node C may report fault information to the controller. It should be understood that, the node A may also sense that the service data being received by the node A is interrupted, and report the fault information to the controller.

In a possible implementation, the controller may further send second configuration information to the node C in advance. If the node C finds that the link between the node A and the node B is faulty, the second configuration information may indicate the node C to flood service topology information to the node A through the local interface with the third attribute. It should be understood that the first configuration information and the second configuration information may be delivered by the controller at the same time, or may be delivered at different time. This is not specifically limited herein.

The controller may further update attributes of the interfaces on the node A, the node B, and the node C based on the reported fault information, and deliver new third configuration information to the node A, the node B, and the node C, to indicate the node A, the node B, and the node C to update the attributes of the local interfaces. Specifically, the attribute of the interface between the node A and the node B is updated to the second attribute. The attribute of the interface between the node A and the node C is updated to the first attribute. The node A, the node B, and the node C flood the service topology information based on the respective new interface attributes. It should be understood that, interface attributes of other nodes that are not related to the link fault and that are in a network may remain unchanged, and the controller does not need to update interface attributes of all nodes globally.

It should be understood that, because the previous interface with the third attribute on the node A is upgraded to an interface with the first attribute, the controller may further reconfigure an interface with the third attribute for the node A, to cope with a link fault. For example, if a link between the node A and the node C is faulty later, the node A may receive service topology information flooded by a node D through the new interface with the third attribute.

The following uses FIG. 4 as an example for further description in some specific application scenarios.

Scenario 1: A Tributary Port is Faulty

For example, the interface on the node 16 corresponding to the node 29 is with the first attribute. An interface on the node 16 corresponding to the node 10 is with the third attribute. If a link between the node 16 and the node 29 is faulty, the node 16 temporarily cannot receive service topology information flooded by the node 29. The node 29 and the node 16 may report fault information to the controller. The controller updates attributes of the interfaces on the node 16, the node 10, and the node 29. A specific updated state may be shown in FIG. 5. The controller updates the attribute of the interface between the node 10 and the node 16 to the first attribute, and updates the attribute of the interface between the node 16 and the node 29 to the second attribute. Moreover, the controller may further update an attribute of an interface between the node 16 and the node 25 to the third attribute. The controller delivers the updated interface attributes to the node 16, the node 10, the node 29, and the node 25 based on new configuration information.

Scenario 2: A Line Port is Faulty

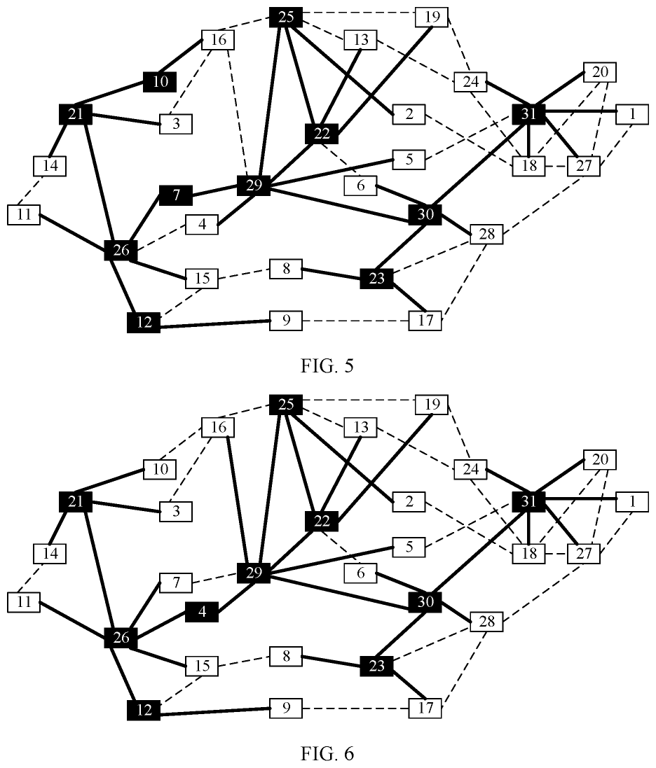

For example, a current flooding path of the service topology information is node 26→node 7→node 29→node 4. An attribute of an interface between the node 26 and the node 4 is the third attribute. If a link between the node 7 and the node 29 is faulty, the node 29 temporarily cannot receive service topology information flooded by the node 7, and the node 4 temporarily cannot receive service topology information flooded by the node 29. The node 7 and the node 29 may report fault information to the controller. The controller updates attributes of interfaces on the node 26, the node 4, the node 7, and the node 29. A specific updated state may be shown in FIG. 6. The controller updates the attribute of the interface between the node 26 and the node 4 to the first attribute, and updates the attribute of the interface between the node 7 and the node 29 to the second attribute. The controller delivers the updated interface attributes to the node 26, the node 4, the node 7, and the node 29 based on new configuration information. An updated flooding path of the service topology information may be node 26→node 7, and node 26→node 4→node 29.

Scenario 3: A Node is Faulty

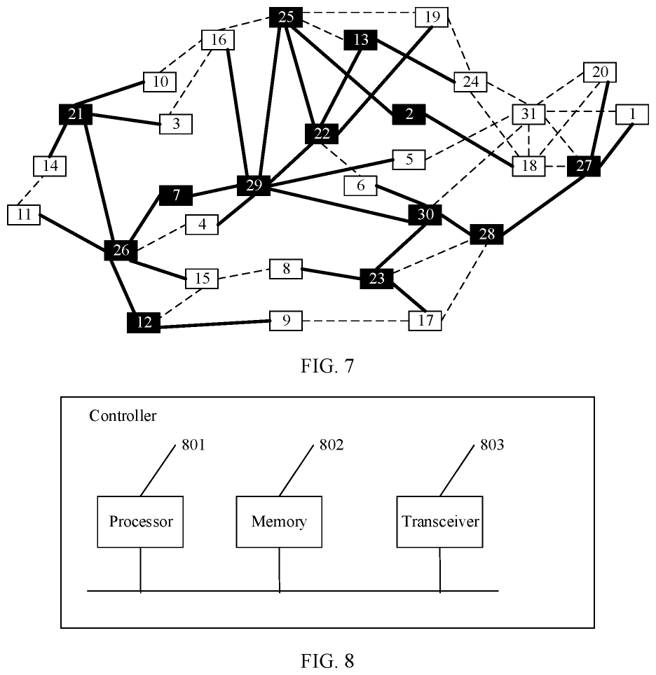

For example, if a node 31 is faulty, all interfaces on the node 31 may be unavailable. In this case, a node 24, a node 18, a node 27, a node 1, and a node 20 may temporarily fail to receive service topology information flooded by the node 31. The node 24, the node 18, the node 27, the node 1, and the node 20 may report fault information to the controller. The controller updates attributes of interfaces on the node 24, the node 18, the node 27, the node 1, and the node 20. An updated state may be shown in FIG. 7. The controller may update the attribute of the interface between a node 13 and the node 24 to the first attribute, the attribute of the interface between a node 2 and the node 18 to the first attribute, the attribute of the interface between a node 28 and the node 27 to the first attribute, the attribute of the interface between the node 27 and the node 1 to the first attribute, and the attribute of the interface between the node 27 and the node 20 to the first attribute. Moreover, the controller may further configure a new interface with the third attribute for each of the foregoing nodes. The controller may update the attribute of the interface between the node 24 and the node 18 to the third attribute, the attribute of the interface between the node 20 and the node 18 to the third attribute, and the attribute of the interface between the node 27 and the node 18 to the third attribute. There is no interface with the third attribute on the node 5 and the node 1. The controller delivers the updated interface attributes to the foregoing nodes based on new configuration information.

In embodiments of this application, because the quantity of flooding paths in the target network is less than the quantity of flooding paths in the original network, a flooding process of the service topology information between nodes is different from that of the control topology information, and each node may flood the service topology information only through a specified interface, but not flood the service topology information to adjacent nodes of all interfaces. This reduces flooding paths of the service topology information and lightens burdens of network bandwidth and processing burdens of each node. Moreover, in this application, the nodes do not need to determine respective interface attributes through packet interaction. The interface attributes of each node are determined by the controller together. In this way, global performance is better and applicability is wider.

The following describes a controller and a node provided in this application.

FIG. 8 is a schematic diagram of a structure of a controller according to an embodiment of this application. The controller includes a processor 801, a memory 802, and a transceiver 803. The processor 801, the memory 802, and the transceiver 803 are connected to each other through a line. The memory 802 is configured to store program instructions and data. It should be noted that the transceiver 803 is configured to perform sending and receiving operations of the information in the embodiment shown in FIG. 2. The processor 801 is configured to perform operations other than information sending and receiving in the embodiment shown in FIG. 2.

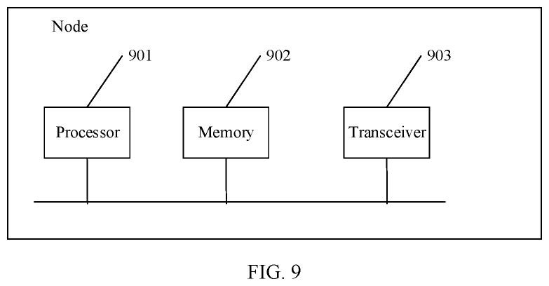

FIG. 9 is a schematic diagram of a structure of a node according to an embodiment of this application. The node includes a processor 901, a memory 902, and a transceiver 903. The processor 901, the memory 902, and the transceiver 903 are connected to each other through a line. The memory 902 is configured to store program instructions and data. It should be noted that the transceiver 903 is configured to perform sending and receiving operations of the information in the embodiment shown in FIG. 2. The processor 901 is configured to perform operations other than information sending and receiving in the embodiment shown in FIG. 2.

It should be noted that the processors shown in FIG. 8 and FIG. 9 may execute a related program by using a general-purpose central processing unit (CPU), a microprocessor, an application-specific integrated circuit ASIC, or at least one integrated circuit, to implement the technical solutions provided in embodiments of this application. The memories shown in FIG. 8 and FIG. 9 may store an operating system and another application program. When the technical solutions provided in embodiments of this application are implemented by using software or firmware, program code used to implement the technical solutions provided in embodiments of this application is stored in the memory, and is executed by the processor. In an embodiment, the processor may include the memory inside. In another embodiment, the processor and the memory are two independent structures.

It may be clearly understood by a person skilled in the art that, for the purpose of convenient and brief description, for a detailed working process of the foregoing systems, apparatuses, and units, refer to a corresponding process in the foregoing method embodiments, and details are not described herein again.

A person of ordinary skill in the art may understand that all or some of the steps in the foregoing embodiments may be implemented by hardware or a program instructing related hardware. The program may be stored in a computer-readable storage medium. The storage medium may be a read-only memory, a random access memory, or the like. Specifically, for example, the foregoing processing unit or processor may be a central processing unit, a general-purpose processor, a digital signal processor (DSP), an application-specific integrated circuit (ASIC), a field programmable gate array (FPGA) or another programmable logic device, a transistor logic device, a hardware component, or any combination thereof. Whether these functions are performed by hardware or software depends on particular applications and design constraints of the technical solutions. A person skilled in the art may use different methods to implement the described functions for each particular application, but it should not be considered that the implementation goes beyond the scope of this application.

When software is used to implement embodiments, all or some of the method steps in embodiments may be implemented in a form of a computer program product. The computer program product includes one or more computer instructions. When the computer program instructions are loaded and executed on a computer, the procedure or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid state disk Solid State Disk (SSD)), or the like.

Finally, it should be noted that the foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A node configuration method, comprising:
determining, by a controller, a target network based on an original network, wherein the original network is for flooding control topology information, the target network is for flooding service topology information, and a quantity of flooding paths in the target network is less than a quantity of flooding paths in the original network;
determining, by the controller, attributes of all interfaces on each node, wherein the attributes of the interfaces comprise a first attribute and a second attribute, an interface with the first attribute is configured to flood the service topology information, and an interface with the second attribute is not configured to flood the service topology information; and
generating, by the controller, first configuration information based on the attributes of all the interfaces on each node, and sending, to each node, the first configuration information corresponding to each node, wherein the first configuration information indicates each node to configure the attributes of all the local interfaces.

2. The method according to claim 1, wherein the determining, by the controller, a target network based on an original network comprises:
determining, by the controller, the target network based on the original network and a minimum spanning tree algorithm, wherein the target network has a smallest quantity of flooding paths.

3. The method according to claim 1, wherein the attributes of the interfaces further comprise a third attribute, an interface with the third attribute is a backup interface that is on a node and that is for flooding the service topology information, a first node and a second node comprise the interface with the third attribute, and the method further comprises:
sending, by the controller, second configuration information to the first node, wherein if a link between an interface with the first attribute on the second node and an interface with the first attribute on a third node is faulty, the second configuration information indicates the first node to flood the service topology information to the interface with the third attribute on the second node through the local interface with the third attribute.

4. The method according to claim 1, wherein if a link between an interface with the first attribute on a second node and an interface with the first attribute on a third node is faulty, the method further comprises:
receiving, by the controller, fault information sent by the second node and/or the third node, wherein the fault information indicates that the link is faulty.

5. The method according to claim 4, wherein the attributes of the interfaces further comprise a third attribute, an interface with the third attribute is a backup interface that is on a node and that is for flooding the service topology information, a first node and the second node comprise the interface with the third attribute, and the method further comprises:
updating, by the controller, an attribute of the interface on the first node, attributes of the interfaces on the second node, and an attribute of the interface on the third node based on the fault information, wherein the attribute of the interface between the second node and the third node is updated to the second attribute, and the attribute of the interface between the first node and the second node is updated to the first attribute; and
generating, by the controller, third configuration information, and sending the third configuration information to the first node, the second node, and the third node, wherein the third configuration information indicates the first node, the second node, and the third node to update the attributes of the local interfaces.

6. The method according to claim 1, wherein the control topology information comprises a link-state advertisement (LSA), and the service topology information comprises traffic engineering (TE) topology information.

7. A controller, comprising: a processor, a memory, and a transceiver, wherein the processor, the memory, and the transceiver are connected to each other through a line;
the processor is configured to:
determine a target network based on an original network, wherein the original network is for flooding control topology information, the target network is for flooding service topology information, and a quantity of flooding paths in the target network is less than a quantity of flooding paths in the original network;
determine attributes of all interfaces on each node, wherein the attributes of the interfaces comprise a first attribute and a second attribute, an interface with the first attribute is configured to flood the service topology information, and an interface with the second attribute is not configured to flood the service topology information; and
generate first configuration information based on the attributes of all the interfaces on each node; and
the transceiver is configured to:
send, to each node, the first configuration information corresponding to each node, wherein the first configuration information indicates each node to configure the attributes of all the local interfaces.

8. The controller according to claim 7, wherein the processor is specifically configured to:
determine the target network based on the original network and a minimum spanning tree algorithm, wherein the target network has a smallest quantity of flooding paths.

9. The controller according to claim 7, wherein the attributes of the interfaces further comprise a third attribute, an interface with the third attribute is a backup interface that is on a node and that is for flooding the service topology information, a first node and a second node comprise the interface with the third attribute, and the processor is further configured to:
send second configuration information to the first node, wherein if a link between an interface with the first attribute on the second node and an interface with the first attribute on a third node is faulty, the second configuration information indicates the first node to flood the service topology information to the interface with the third attribute on the second node through the local interface with the third attribute.

10. The controller according to claim 7, wherein if a link between an interface with the first attribute on a second node and an interface with the first attribute on a third node is faulty, the transceiver is further configured to:
receive fault information sent by the second node and/or the third node, wherein the fault information indicates that the link is faulty.

11. The controller according to claim 10, wherein the attributes of the interfaces further comprise a third attribute, an interface with the third attribute is a backup interface that is on a node and that is for flooding the service topology information, a first node and the second node comprise an interface with the third attribute, the processor is further configured to:
update an attribute of the interface on the first node, attributes of the interfaces on the second node, and an attribute of the interface on the third node based on the fault information, wherein the attribute of the interface between the second node and the third node is updated to the second attribute, and the attribute of the interface between the first node and the second node is updated to the first attribute; and
generate third configuration information; and
the transceiver is further configured to:
send the third configuration information to the first node, the second node, and the third node, wherein the third configuration information indicates the first node, the second node, and the third node to update the attributes of the local interfaces.

12. The controller according to claim 7, wherein the control topology information comprises a link-state advertisement (LSA) and the service topology information comprises traffic engineering (TE) topology information.

13. A node, comprising: a processor, a memory, and a transceiver, wherein the processor, the memory, and the transceiver are connected to each other through a line;
the transceiver is configured to:
receive first configuration information sent by a controller, wherein the first configuration information is generated by the controller based on attributes of all interfaces on the node, the attributes of the interfaces comprise a first attribute and a second attribute, an interface with the first attribute is configured to flood service topology information, and an interface with the second attribute is not configured to flood the service topology information, wherein a quantity of flooding paths of the service topology information in a network in which the node is located is less than a quantity of flooding paths of control topology information; and
the processor is configured to:
configure the attributes of all the local interfaces based on the first configuration information.

14. The node according to claim 13, wherein the node further comprises an interface with a third attribute, and the interface with the third attribute is a backup interface that is on the node and that is for flooding the service topology information;
the transceiver is further configured to:
receive second configuration information sent by the controller; and
if a link between an interface with the first attribute on a first node and an interface with the first attribute on a second node is faulty, the processor is further configured to:
flood the service topology information to the first node through the local interface with the third attribute based on an indication of the second configuration information.

15. The node according to claim 13, wherein if a link between an interface with the first attribute on the node and a peer interface is faulty, the transceiver is further configured to:
send fault information to the controller, wherein the fault information indicates that the link is faulty; and
receive third configuration information sent by the controller; and
the processor is further configured to:
update the attributes of the local interfaces based on the third configuration information.

16. A non-transitory computer readable medium, comprising computer instructions, wherein when the computer instructions are run on a computer device, the computer device is enabled to perform a node configuration method, wherein the method comprises:
determining, by a controller, a target network based on an original network, wherein the original network is for flooding control topology information, the target network is for flooding service topology information, and a quantity of flooding paths in the target network is less than a quantity of flooding paths in the original network;
determining, by the controller, attributes of all interfaces on each node, wherein the attributes of the interfaces comprise a first attribute and a second attribute, an interface with the first attribute is configured to flood the service topology information, and an interface with the second attribute is not configured to flood the service topology information; and
generating, by the controller, first configuration information based on the attributes of all the interfaces on each node, and sending, to each node, the first configuration information corresponding to each node, wherein the first configuration information indicates each node to configure the attributes of all the local interfaces.

17. The non-transitory computer readable medium according to claim 16, wherein the determining, by the controller, a target network based on an original network comprises:
determining, by the controller, the target network based on the original network and a minimum spanning tree algorithm, wherein the target network has a smallest quantity of flooding paths.

18. The non-transitory computer readable medium according to claim 16, wherein the attributes of the interfaces further comprise a third attribute, an interface with the third attribute is a backup interface that is on a node and that is for flooding the service topology information, a first node and a second node comprise the interface with the third attribute, and the method further comprises:
sending, by the controller, second configuration information to the first node, wherein if a link between an interface with the first attribute on the second node and an interface with the first attribute on a third node is faulty, the second configuration information indicates the first node to flood the service topology information to the interface with the third attribute on the second node through the local interface with the third attribute.

19. The non-transitory computer readable medium according to claim 1, wherein if a link between an interface with the first attribute on a second node and an interface with the first attribute on a third node is faulty, the method further comprises:
receiving, by the controller, fault information sent by the second node and/or the third node, wherein the fault information indicates that the link is faulty.

20. The non-transitory computer readable medium according to claim 19, wherein the attributes of the interfaces further comprise a third attribute, an interface with the third attribute is a backup interface that is on a node and that is for flooding the service topology information, a first node and the second node comprise the interface with the third attribute, and the method further comprises:
updating, by the controller, an attribute of the interface on the first node, attributes of the interfaces on the second node, and an attribute of the interface on the third node based on the fault information, wherein the attribute of the interface between the second node and the third node is updated to the second attribute, and the attribute of the interface between the first node and the second node is updated to the first attribute; and
generating, by the controller, third configuration information, and sending the third configuration information to the first node, the second node, and the third node, wherein the third configuration information indicates the first node, the second node, and the third node to update the attributes of the local interfaces.
